(19) United States
(12) Patent Application Publication
(10) Pub. No.: US 2026/0289535 A1
(43) Pub. Date: Sep. 24, 2026

(54) INFORMATION PROCESSING APPARATUS, BILLING AMOUNT OUTPUT METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Koichiro OTA, Omachi-shi (JP); Toshiki FUJIMORI, Chino-shi (JP)

(73) Assignee: SEIKO EPSON CORPORATION, Tokyo (JP)

(21) Appl. No.: 19/571,021

(22) Filed: Mar. 18, 2026

(30) Foreign Application Priority Data
Mar. 18, 2025 (JP) 2025-043674

(51) Int. Cl. G06Q 20/10; G06T 7/00

(52) U.S. Cl. CPC G06Q 20/102; G06T 7/0004

(57) ABSTRACT

According to an aspect of the present disclosure, there is provided an information processing apparatus that executes acquiring at least one of identification information indicating a projection apparatus and identification information indicating a user of the projection apparatus, acquiring deterioration information concerning deterioration of image quality of the projection apparatus in a first period, acquiring fee information concerning a usage fee of the projection apparatus, and outputting a billing amount relating to the projection apparatus in the first period based on the deterioration information and the fee information.

The present application is based on, and claims priority from JP Application Serial Number 2025-043674, filed Mar. 18, 2025, the disclosure of which is hereby incorporated by reference herein in its entirety.

### BACKGROUND

### 1. Technical Field

The present disclosure relates to an information processing apparatus, a billing amount output method, and a non-transitory computer-readable storage medium storing a program.

### 2. Related Art

A service of lending a projection apparatus such as a projector to a user according to a contract with the user is publicly known. JP-A-2017-174391 discloses that equipment such as an electronic blackboard, a projector, and a copier is rented for a fee. JP-A-2017-174391 discloses that a rental fee for the equipment is determined by simple time-based billing based on an occupancy time of the equipment.

JP-A-2017-174391 is an example of the related art.

The lending service of the related art has a problem in that deterioration of the projection apparatus is not taken into consideration in determining a billing amount.

For example, projectors deteriorate over time. For this reason, when the projector is lent for a long period of time, the quality of a service provided to a user by the projector is likely to differ between a time immediately after the projector was lent and a time after a long period has elapsed since the projector was lent. Under such a situation, when a billing amount is determined based on the simple time-based billing, it is likely that a service worth the billing amount cannot be provided.

### SUMMARY

According to an aspect of the present disclosure, there is provided an information processing apparatus that executes: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

According to an aspect of the present disclosure, there is provided a billing amount output method including: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

According to an aspect of the present disclosure, there is provided a non-transitory computer-readable storage medium storing a program for causing a computer to execute: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

### BRIEF DESCRIPTION OF THE DRAWINGS

FIG. 1 is a configuration example including a projection apparatus management system according to a first embodiment of the present disclosure.

FIG. 2 is a configuration example of a registration processing apparatus.

FIG. 3 is a configuration example of a billing processing apparatus.

FIG. 4 is a configuration example of a storage device of the registration processing apparatus.

FIG. 5 is a configuration example of a storage device of the billing processing apparatus.

FIG. 6 is a configuration example of a projection apparatus.

FIG. 7 is a configuration example of registration information.

FIG. 8 is a configuration example of contract information.

FIG. 9 is a flowchart illustrating an example of a flow of operation result report output processing in the projection apparatus management system.

FIG. 10 is a display example of an operation result report.

FIG. 11 is a flowchart illustrating an example of a flow of invoice output processing in the projection apparatus management system.

FIG. 12 is a configuration example of an invoice.

FIG. 13 is a configuration example of contract information according to a modification 1.

FIG. 14 is a configuration example including the projection apparatus management system according to a modification 2.

FIG. 15 is a flowchart illustrating an example of a flow of invoice output processing according to a modification 3.

FIG. 16 is a graph illustrating an example of fee information according to a modification 4.

### DESCRIPTION OF EMBODIMENTS

Hereinafter, embodiments of the present disclosure are explained with reference to the accompanying drawings.

### First Embodiment

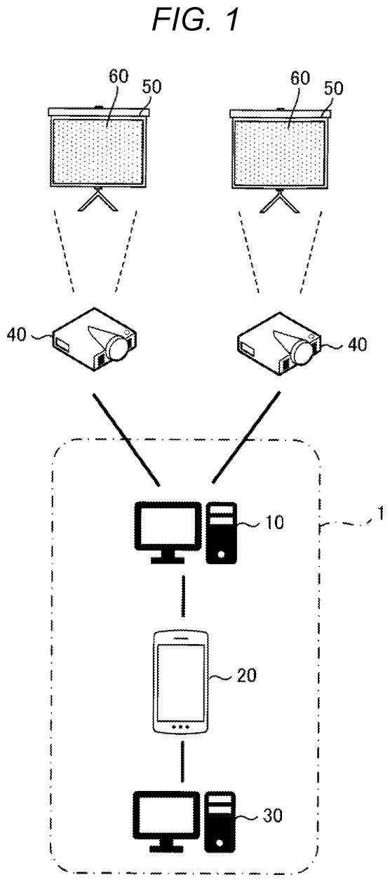

In FIG. 1, a configuration example including a projection apparatus management system 1 according to a first embodiment of the present disclosure is illustrated. The projection apparatus management system 1 includes a registration processing apparatus 10, a terminal 20, and a billing processing apparatus 30. The projection apparatus management system 1 manages one or more projection apparatuses 40. The billing processing apparatus 30 is an example of an information processing apparatus according to the present embodiment.

The registration processing apparatus 10 and the terminal 20 are connected via a communication network. The terminal 20 and the billing processing apparatus 30 are connected via the communication network. The communication network may include a wired communication network. The communication network may include a wireless communication network.

The projection apparatus 40 is, for example, a projector. The projection apparatus 40 includes a light source. The projection apparatus 40 modulates light from the light source with a light modulation device. Accordingly, the projection apparatus 40 projects a projection image 60 onto a projection area 50. The projection area 50 is, for example, a projection screen installed in a conference room. The projection area 50 is not limited to the projection screen. The projection image 60 may include a still image. The projection image 60 may include a moving image. The projection apparatus 40 may output sound in addition to projecting the projection image 60.

The projection apparatus 40 may be a projection apparatus other than the projector. The projection apparatus 40 may display an image not by projection instead of or in addition to projecting the projection image 60. For example, the projection apparatus 40 may be a projection apparatus including a liquid crystal display device or a light emitting diode (LED) display device.

The projection apparatus 40 may be a lending target. For example, an owner of the projection apparatus 40 may be a company that operates a lending business. A user of the projection apparatus 40 may be a customer, that is, an end user who rents the projection apparatus 40 from the owner of the projection apparatus 40. Hereinafter, “owner” simply referred to in the present specification sometimes means the owner of the projection apparatus 40. Similarly, “user” simply referred to in the present specification sometimes means the user of the projection apparatus 40.

A format of lending is optional. The format of lending may be, for example, a rental format or may be a lease format. A right to purchase the projection apparatus 40 may be given to the user after the end of a lending period.

The terminal 20 may function as an interface terminal for accessing at least one of the registration processing apparatus 10 and the billing processing apparatus 30. The terminal 20 is operated by, for example, the owner of the projection apparatus 40. The terminal 20 is, for example, a mobile terminal. A specific example of the terminal 20 is a personal computer, a smartphone, or a tablet terminal.

In relation to the use of the projection apparatus 40, a fee is billed to the user. The fee is, for example, a fee for lending the projection apparatus 40. The fee for lending is billed, for example, on a monthly basis. The projection apparatus management system 1 executes a billing amount output method as the method described in the present specification. In particular, in the present embodiment, the billing amount output method is executed by the billing processing apparatus 30.

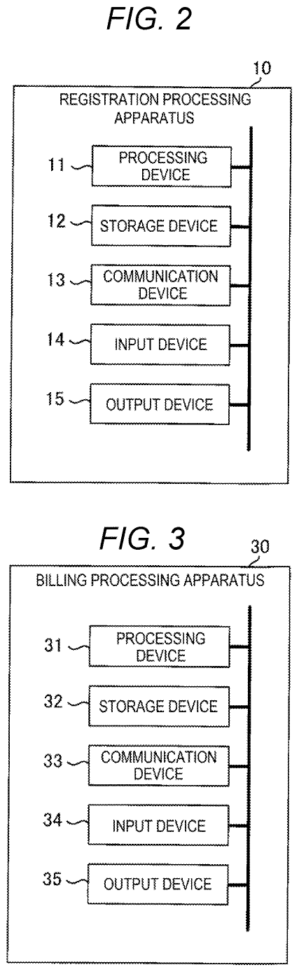

In FIG. 2, a configuration example of the registration processing apparatus 10 is illustrated. The registration processing apparatus 10 has a hardware configuration serving as a publicly-known computer. The registration processing apparatus 10 includes, for example, a processing device 11 and a storage device 12. The processing device 11 includes, for example, a processor. The processor can be manufactured using an integrated circuit, an application specific integrated circuit (ASIC), a field programmable gate array (FPGA), or the like. The storage device 12 includes a storage medium. The storage medium includes, for example, a semiconductor memory device or a magnetic disk device. A part or the entire storage medium may be a non-transitory storage medium.

The registration processing apparatus 10 includes a communication device 13. The communication device 13 is, for example, a network interface. The communication device 13 transmits and receives information by communicating with external apparatuses via a communication network. The external apparatuses are, for example, the projection apparatus 40 and the terminal 20. The external apparatuses may be other computers. The communication device 13 can perform at least one of wired communication and wireless communication.

The registration processing apparatus 10 includes an input device 14 and an output device 15. The input device 14 includes, for example, a keyboard and a mouse. The output device 15 includes, for example, a liquid crystal display device and a printing device. The communication device 13 may function as a part of the input device 14. The communication device 13 may function as a part of the output device 15.

A hardware configuration of the registration processing apparatus 10 is not limited to that illustrated in FIG. 2. The registration processing apparatus 10 may be a computer having another configuration. For example, the registration processing apparatus 10 may have a configuration serving as a publicly-known mobile terminal. The publicly-known mobile terminal is, for example, a mobile phone, a personal computer, a smartphone, or a tablet terminal.

In FIG. 3, a configuration example of the billing processing apparatus 30 is illustrated. The billing processing apparatus 30 has a hardware configuration serving as a publicly-known computer. The billing processing apparatus 30 includes, for example, a processing device 31 and a storage device 32. The processing device 31 includes, for example, a processor. The storage device 32 includes a storage medium.

The billing processing apparatus 30 includes a communication device 33. The communication device 33 transmits and receives information by communicating with an external apparatus via a communication network. The external apparatus is, for example, the terminal 20. The external apparatus may be another computer. The communication device 33 can perform at least one of wired communication and wireless communication.

The billing processing apparatus 30 includes an input device 34 and an output device 35. The communication device 33 may function as a part of the input device 34. The communication device 33 may function as a part of the output device 35.

A hardware configuration of the billing processing apparatus 30 is not limited to that illustrated in FIG. 3. The billing processing apparatus 30 may be a computer having another configuration. For example, the billing processing apparatus 30 may have a configuration serving as a publicly-known mobile terminal.

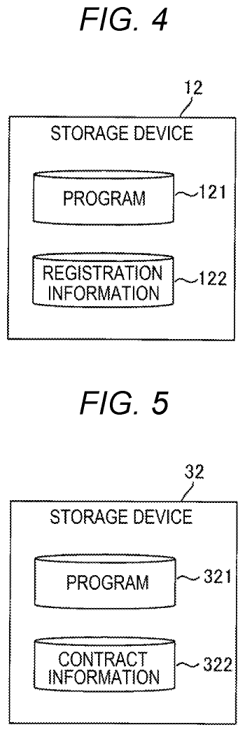

In FIG. 4, a configuration example of the storage device 12 of the registration processing apparatus 10 is illustrated. The storage device 12 stores, for example, a program 121 and registration information 122. The program 121 specifies an operation of the registration processing apparatus 10. By executing the program 121, the registration processing apparatus 10 implements functions explained in the present embodiment. That is, the program 121 causes a computer to function as the registration processing apparatus 10 according to the present embodiment.

In FIG. 5, a configuration example of the storage device 32 of the billing processing apparatus 30 is illustrated. The storage device 32 stores, for example, a program 321 and contract information 322. The program 321 specifies an operation of the billing processing apparatus 30. By executing the program 321, the billing processing apparatus 30 implements functions explained in the present embodiment. That is, the program 321 causes a computer to function as the billing processing apparatus 30 according to the present embodiment.

A configuration of the terminal 20 is not particularly illustrated. The terminal 20 can have a configuration serving as a publicly-known mobile terminal.

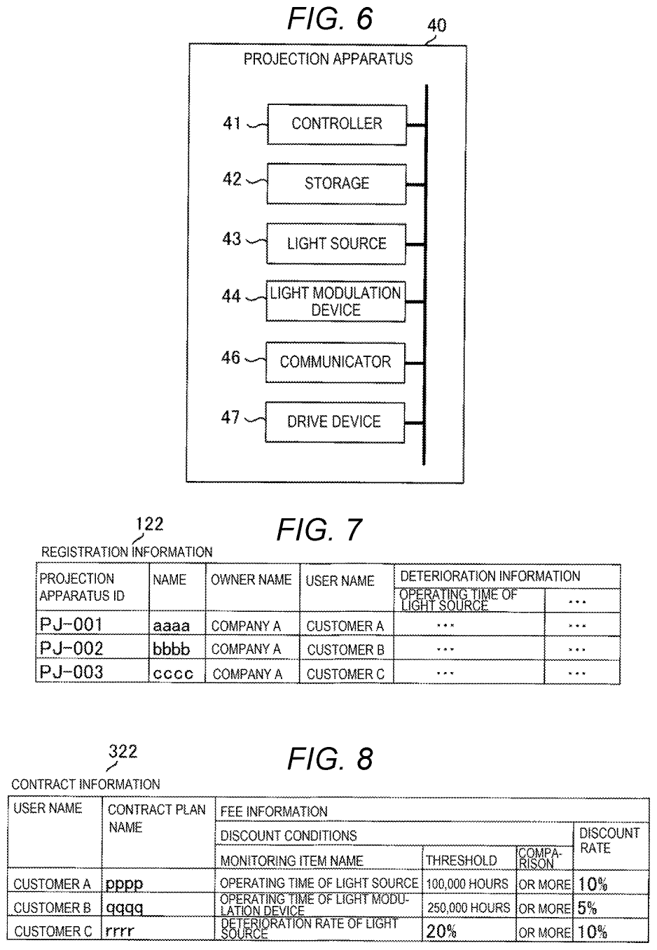

In FIG. 6, a configuration example of the projection apparatus 40 is illustrated. The projection apparatus 40 includes a controller 41, a storage 42, a light source 43, a light modulation device 44, a communicator 46, and a drive device 47. The controller 41 controls an entire operation of the projection apparatus 40.

The storage 42 stores information. The storage 42 may store a not-illustrated program to be executed by the controller 41. The light source 43 emits light. The light modulation device 44 modulates, according to an image that should be projected, the light emitted from the light source 43. The light modulation device 44 may include, for example, a liquid crystal panel. Alternatively, the light modulation device 44 may include, for example, a digital mirror device. The projection image 60 is displayed in the projection area 50 using the light having passed through the light modulation device 44.

The communicator 46 is, for example, a network interface. The communicator 46 transmits and receives information by communicating with an external apparatus via a communication network. The external apparatus is, for example, the registration processing apparatus 10. The communicator 46 can perform at least one of wired communication and wireless communication.

The drive device 47 is a device that shifts the positions of the pixels of the light modulation device 44 and may include, for example, an actuator.

In FIG. 7, a configuration example of the registration information 122 is illustrated. The registration information 122 includes information concerning at least one projection apparatus. The registration information 122 correlates, for each projection apparatus, information concerning the projection apparatus with identification information indicating the projection apparatus. The identification information indicating the projection apparatus is, for example, a projection apparatus ID.

The information concerning the projection apparatus includes a name of the projection apparatus, an owner name that is identification information indicating an owner of the projection apparatus, a user name that is identification information indicating a user of the projection apparatus, and deterioration information of the projection apparatus. The name of the projection apparatus is, for example, a model name of a projector. The owner name is, for example, a name of a company that operates a lending business. The user name is, for example, a name or an appellation of an end user who rents the projection apparatus.

The deterioration information is information concerning deterioration of image quality of the projection apparatus. The deterioration information includes operating time information that is information concerning an operating time of the projection apparatus. For example, the deterioration information includes information concerning an operating time of the light source of the projection apparatus as the operating time information. Since the light source deteriorates because of a long-time operation, it can be said that the operating time of the light source is an example of information concerning deterioration of the light source provided in the projection apparatus.

The deterioration information may include other information concerning the deterioration of the image quality of the projection apparatus in addition to or instead of the operating time of the light source. For example, the deterioration information may include, as the operating time information, information concerning an operating time of the light modulation device or information concerning an operating time of the drive device. Since the light modulation device also deteriorates because of a long-time operation, it can be said that the operating time of the light modulation device is an example of information concerning deterioration of the light modulation device provided in the projection apparatus. Since the drive device also deteriorates because of a long-time operation, it can be said that the operating time of the drive device is an example of information concerning deterioration of the drive device provided in the projection apparatus.

In particular, when the deterioration information is constituted to include at least one of the information concerning the deterioration of the light source, the information concerning the deterioration of the light modulation device, and the information concerning the deterioration of the drive device, deterioration over time of the projection apparatus can be appropriately evaluated. Therefore, a billing amount can be appropriately determined.

The deterioration information may include information indicating a deterioration rate of the light source. An evaluation method and a measurement method for the deterioration rate can be optionally designed by those skilled in the art based on a publicly-known technique or the like.

The deterioration information may be represented for each period. For example, the operating time of the light source and the operating time of the light modulation device may be stored daily or may be stored monthly. The deterioration information may be represented by the latest state. For example, the deterioration rate of the light source may be a deterioration rate measured last.

An owner name and a user name coinciding for a certain projection apparatus in the registration information 122 may indicate that the projection apparatus is in stock in the owner. In that case, it can be said that the projection apparatus is in a state of being able to be optionally lent according to, for example, a contract with a new end user.

In the registration information 122, the projection apparatus ID, the name, the owner name, and the user name are input to the registration processing apparatus 10 via the terminal 20, for example, as explained below. First, the owner of the projection apparatus logs in to the registration processing apparatus 10 via the terminal 20. Subsequently, the owner inputs information concerning one or more projection apparatuses to the registration processing apparatus 10 via the terminal 20. The registration processing apparatus 10 stores the input projection apparatus ID and the input name, the input owner name, and the input user name in correlation with each other in the registration information 122.

When the registration information 122 is already stored, the owner can optionally update the registration information 122. For example, the terminal 20 may display the registration information 122 as a list according to operation of the owner. For example, when a certain projection apparatus is lent to a certain end user, the owner may change a user of the projection apparatus from the owner itself to the end user via the terminal 20. When a certain projection apparatus is returned from an end user to the owner, the owner may change a user of the projection apparatus from the end user to the owner via the terminal 20.

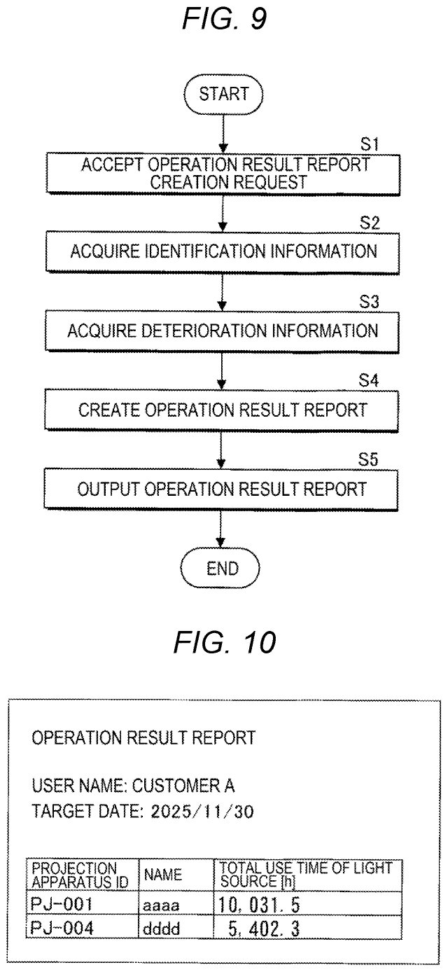

The deterioration information in the registration information 122 is acquired by, for example, the registration processing apparatus 10. The registration processing apparatus 10 acquires deterioration information from each projection apparatus 40 via, for example, a communication network. The registration processing apparatus 10 stores the acquired deterioration information in the registration information 122 in correlation with a projection apparatus ID. Timing for acquiring the deterioration information can be optionally designed. For example, the registration processing apparatus 10 may periodically acquire the deterioration information. Alternatively, for example, the registration processing apparatus 10 may acquire the deterioration information when a specific condition is satisfied. As a specific example, as explained below, the registration processing apparatus 10 may acquire the deterioration information when executing the processing in FIG. 9.

In FIG. 8, a configuration example of the contract information 322 is illustrated. The contract information 322 includes information concerning a contract concluded between an owner of a projection apparatus and at least one user. The contract information 322 correlates, for each contract, a contract holder name, that is, a user name of the projection apparatus and information concerning the contract.

The information concerning the contract includes fee information. The information concerning the contract may further include a contract plan name. The contract plan name is information indicating a type of the contract. The fee information is information concerning a usage fee of the projection apparatus. The fee information includes information concerning a discount of the fee. For example, the fee information includes information indicating discount conditions and information indicating a discount rate.

The discount conditions include information indicating a name of a monitoring item referred to as a target of determining whether to apply the discount, that is, a monitoring item name, a threshold serving as a determination reference, and a comparison method representing a determination method.

The monitoring item may correspond to an item of the deterioration information stored in the registration information 122. The monitoring item is, for example, the operating time of the light source. The monitoring item is, for example, the operating time of the light modulation device. The monitoring item is, for example, the deterioration rate of the light source. Monitoring items other than the above may be defined.

The threshold is set as appropriate according to the monitoring item. When the monitoring item is the operating time of the light source, the threshold is represented by, for example, hours. In this case, the threshold is, for example, 100,000 hours. When the monitoring item is the operating time of the light source, “or more” is designated as the comparison method.

When the monitoring item is the operating time of the light modulation device, the threshold is also represented by, for example, hours. In this case, the threshold is, for example, 250,000 hours. When the monitoring item is the operating time of the light modulation device, “or more” is designated as the comparison method.

When the monitoring item is the deterioration rate of the light source, the threshold is represented by, for example, a rate. In this case, the threshold is, for example, 20%. When the monitoring item is the deterioration rate of the light source, “or more” is designated as the comparison method.

As the comparison method, “or less”, “more than”, “less than”, “equal”, or the like may be designated according to the monitoring item.

In an example of a customer A in FIG. 8, when the operating time of the light source is 100,000 hours or more, 10% of the fee is reduced. Similarly, in an example of a customer B, when the operating time of the light modulation device is 250,000 hours or more, 5% of the fee is reduced. Similarly, in an example of a customer C, when the deterioration rate of the light source is 20% or more, 10% of the fee is reduced.

The contract information 322 is input to the billing processing apparatus 30 via the terminal 20, for example, as explained below. First, the owner of the projection apparatus logs in to the billing processing apparatus 30 via the terminal 20. Subsequently, the owner inputs information concerning one or more users to the billing processing apparatus 30. The billing processing apparatus 30 stores the input information as the contract information 322. When the contract information 322 is already stored, the owner can optionally update the contract information 322. For example, the terminal 20 may display the contract information 322 as a list according to operation of the owner.

FIG. 9 is a flowchart illustrating an example of a flow of operation result report output processing in the projection apparatus management system 1. This processing is executed by, for example, the registration processing apparatus 10. The processing in FIG. 9 is started when the registration processing apparatus 10 accepts an operation result report creation request in step S1.

The operation result report creation request is input via the terminal 20 by, for example, the owner of the projection apparatus. In response to accepting the operation result report creation request, the terminal 20 transmits the operation result report creation request to the registration processing apparatus 10. The registration processing apparatus 10 accepts the operation result report creation request in response to receiving the operation result report creation request.

The operation result report creation request includes, for example, information indicating identification information, a target period, and a monitoring item name. The identification information includes at least one of a projection apparatus ID and a user name. The target period includes, for example, a start point and an end point. The target period is, for example, a first period. The monitoring item name includes, for example, any one of monitoring item names defined by the contract information 322. There may be a plurality of pieces of identification information. There may be a plurality of target periods. There may be a plurality of monitoring item names.

Subsequently, in step S2, the registration processing apparatus 10 acquires identification information from the operation result report creation request. As explained above, the identification information includes at least one of the projection apparatus ID, that is, the identification information indicating the projection apparatus and the user name, that is, the identification information indicating the user of the projection apparatus.

Subsequently, in step S3, the registration processing apparatus 10 acquires deterioration information of the projection apparatus. The deterioration information is acquired, for example, in the first period, that is, in a target period designated by the operation result report creation request.

Here, when the projection apparatus ID is acquired in step S2, the registration processing apparatus 10 can acquire the deterioration information of the projection apparatus by searching through the registration information 122 based on the projection apparatus ID. When the user name is acquired in step S2, the registration processing apparatus 10 can extract one or more projection apparatuses by searching through the registration information 122 based on the user name and thereafter can further acquire deterioration information for the projection apparatuses.

Subsequently, in step S4, the registration processing apparatus 10 creates an operation result report.

In FIG. 10, a display example of the operation result report is illustrated. The operation result report is created, for example, for each user. The operation result report includes a user name, an output period, and operation result information of one or more projection apparatuses. The user name is acquired in step S2 or can be acquired based on the projection apparatus ID acquired in step S2. The output period is the target period included in the operation result report creation request.

The operation result information includes the projection apparatus ID, the name of the projection apparatus, and a value of a monitoring item corresponding to the monitoring item name included in the operation result report creation request. The value of the monitoring item is acquired, for example, by searching through the registration information 122 based on the projection apparatus ID. As a specific example, when the monitoring item name is the operating time of the light source, the value of the monitoring item is acquired as a numerical value in time units or second units.

As an example, when the user name is input in step S1, the operation result information is output for all projection apparatuses correlated with the user name in the registration information 122. As another example, when one or more projection apparatus IDs are input in step S1, the operation result information is output for projection apparatuses corresponding to the acquired projection apparatus IDs.

In the example illustrated in FIG. 10, as a total operating time of the light source, which is a cumulative value of the value of the monitoring item, for example, a value of a total operating time, that is, a total use time of the light source from the start of lending of the projection apparatuses until Nov. 30, 2025 is included. As a modification, the operation result information may further include a cumulative value of the value of the monitoring items in a predetermined period. For example, a value of an operating time only in November, 2025 of the projection apparatuses or a value of a total operating time of the light source from the shipment of the projection apparatuses until Nov. 30, 2025 may be included.

Subsequently, in step S5, the registration processing apparatus 10 outputs an operation result report. The output of the operation result report in the registration processing apparatus 10 is executed, for example, by transmitting the operation result report to the terminal 20. A format in the transmission is optional. For example, an HTML file may be used. For example, a CSV file may be used.

The terminal 20 acquires the operation result report by receiving the same. The terminal 20 outputs the operation result report. The output of the operation result report in the terminal 20 is executed, for example, by displaying a screen illustrated in FIG. 10. The terminal 20 may store the operation result report.

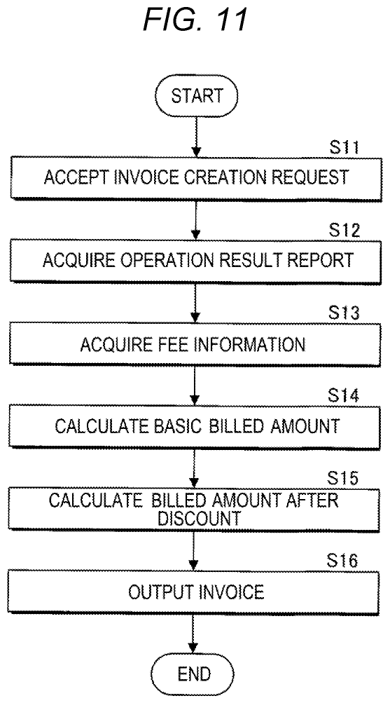

FIG. 11 is a flowchart illustrating an example of a flow of invoice output processing in the projection apparatus management system 1. This processing is executed by, for example, the billing processing apparatus 30. The processing in FIG. 11 is started when the billing processing apparatus 30 accepts an invoice creation request in step S11.

The invoice creation request is input by, for example, the owner of the projection apparatus via the terminal 20. In response to accepting the invoice creation request, the terminal 20 transmits the invoice creation request to the billing processing apparatus 30. The billing processing apparatus 30 accepts the invoice creation request in response to receiving the invoice creation request.

The invoice creation request includes, for example, an operation result report. As the operation result report, for example, the operation result report acquired by the terminal 20 in step S5 in FIG. 9 can be used.

Subsequently, in step S12, the billing processing apparatus 30 acquires the operation result report. For example, as explained above, the operation result report is included in the invoice creation request received in step S11.

Subsequently, in step S13, the billing processing apparatus 30 acquires fee information. The fee information is acquired, for example, by searching through the contract information 322 based on a user name included in the operation result report.

Subsequently, in step S14, the billing processing apparatus 30 acquires a basic billing amount in the fee information. The basic billing amount is an amount described in the contract information 322 when the owner bills the user in a target period, and is, for example, a billing amount before discount. The basic billing amount may be calculated as an amount in a target period included in the operation result report. The basic billing amount may be calculated for each projection apparatus based on a value of a monitoring item included in the operation result report.

Subsequently, in step S15, the billing processing apparatus 30 calculates a billing amount after the discount. Step S15 is a billing amount output step. For example, for each projection apparatus, the billing processing apparatus 30 determines, based on deterioration information of the projection apparatus, whether the value of the monitoring item satisfies a discount condition. When the value of the monitoring item satisfies the discount condition, the billing processing apparatus 30 executes a discount by reducing the billing amount.

For example, in the example illustrated in FIG. 8, when a cumulative operating time of a light source of a certain projection apparatus relating to the customer A is 100,000 hours or more, 10% reduction is performed for the projection apparatus with respect to each projection apparatus associated with the customer A. When the cumulative operating time of the light source of the projection apparatus is less than 100,000 hours, reduction is not performed for the projection apparatus.

Here, the deterioration information may be transmitted to the billing processing apparatus 30, for example, as a part of the invoice creation request or the operation result report. Alternatively, the billing processing apparatus 30 may communicate with the registration processing apparatus 10 in response to the invoice creation request and acquire deterioration information of each projection apparatus from the registration processing apparatus 10. For example, when the monitoring item includes the total use time of the light source and the total use time of the light source is not included in the operation result report, the billing processing apparatus 30 may acquire the total use time of the light source by receiving the total use time from the registration processing apparatus 10.

Subsequently, in step S16, the billing processing apparatus 30 outputs an invoice. An output form of the invoice can be optionally designed. For example, the invoice may be output by being printed using a printing device connected to the billing processing apparatus 30. Alternatively, the invoice may be output by transmitting data representing the invoice to a transmission destination designated by the user.

In the invoice, a billing amount is output. As explained above, the billing amount is output as the billing amount relating to the projection apparatus in the target period based on the deterioration information and the fee information.

As explained above, the billing processing apparatus 30 outputs the billing amount based on the deterioration information of the projection apparatus. For this reason, the billing amount can be appropriately determined according to, for example, deterioration over time of the projection apparatus.

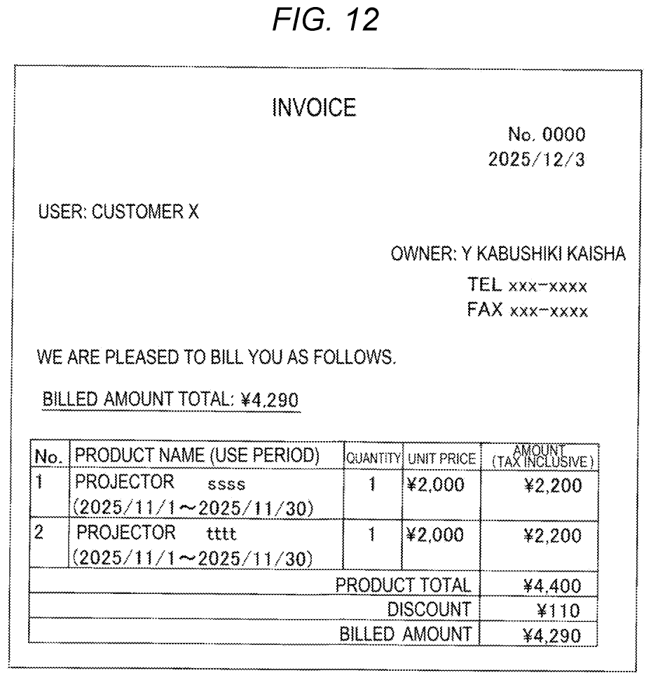

In FIG. 12, a configuration example of the invoice is illustrated. The invoice is created, for example, for each user. The invoice includes a user name, an owner name, and billing amount information. The billing amount information includes a total of billing amounts to the user and billing details. The billing details include basic billing amounts for projection apparatuses, a total of the basic billed amounts, and a reduction relating to a discount.

In the example illustrated in FIG. 12, a fee relating to two projection apparatuses is billed to a customer X, who is a user. Both of the basic billing amounts of the projection apparatuses are 2,200 yen. The total of the basic billing amounts is 4,400 yen. As a result of reducing 5%, that is, 110 yen for one of the projection apparatuses based on deterioration information, a total billing amount after the discount is 4,290 yen.

Although not illustrated in FIG. 12, details about the discount may be output. For example, for which of the projection apparatuses the discount is executed may be indicated. For example, fee information and deterioration information relating to the discount may be indicated. Accordingly, the user can learn that, for example, a discount has been applied because a total use time of a light source of a certain projection apparatus has exceeded a threshold.

As explained above, according to the first embodiment, the billing processing apparatus 30 outputs the billing amount based on the deterioration information of the projection apparatus. For this reason, the billing amount can be appropriately determined according to, for example, deterioration over time of the projection apparatus.

### Modification 1

A modification 1 is an embodiment in which the projection apparatus management system 1 is changed to be able to consider a plurality of discount conditions in the first embodiment. Hereinafter, the modification 1 is explained. In the following explanation, explanation is sometimes omitted about portions common to the first embodiment.

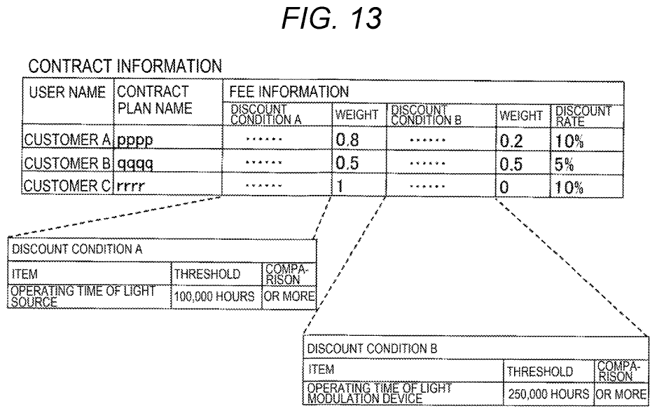

In FIG. 13, a configuration example of contract information according to the modification 1 is illustrated. For convenience of illustration, some of the discount conditions are divided and illustrated in FIG. 13. The contract information includes a plurality of discount conditions. In the example illustrated in FIG. 13, a discount condition A and a discount condition B are included. In the contract information, weights are correlated with the respective discount conditions. The weights are defined such that, for example, a sum of the weights is 1 for each user.

In the example illustrated in FIG. 13, when a projection apparatus of the customer A satisfies the discount condition A, of a discount rate 10%, a value corresponding to the weight of the discount condition A, that is, 8% is reduced. Similarly, when the projection apparatus of the customer A satisfies the discount condition B, of the discount rate 10%, a value corresponding to the weight of the discount condition B, that is, 2% is reduced. Further, when the projection apparatus of the customer A satisfies both the discount conditions A and B, the entire discount rate, that is, 10% is reduced.

According to the modification 1, it is possible to provide a flexible contract form by combining various discount conditions.

### Modification 2

A modification 2 is an embodiment in which the method of acquiring deterioration information is changed in the first embodiment or the modification 1. Hereinafter, the modification 2 is explained. In the following explanation, explanation is sometimes omitted about portions common to the first embodiment or the modification 1.

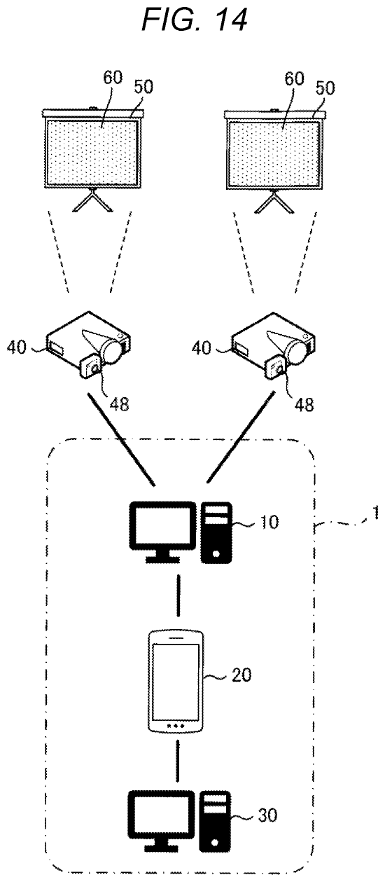

In FIG. 14, a configuration example including the projection apparatus management system 1 according to the modification 2 is illustrated. The projection apparatus 40 includes a camera 48. The camera 48 is an example of an imaging device. The camera 48 acquires a captured image by capturing the projection image 60.

Deterioration information according to the modification 2 is, for example, a deterioration rate of a light source of a projection apparatus. The deterioration rate of the light source is measured by, for example, a calibration operation of the projection apparatus 40. Those skilled in the art can optionally design the calibration operation based on a publicly-known technique or the like. Hereinafter, an example of the calibration operation is explained.

The registration processing apparatus 10 periodically transmits a start request and a calibration request to each projection apparatus. Each projection apparatus starts by executing a start sequence in response to receiving the start request. Each projection apparatus executes the calibration operation in response to receiving the calibration request.

The calibration operation includes, for example, processing of estimating a deterioration rate of the luminance of the light source. In the calibration operation, first, the projection apparatus 40 projects a white image onto the projection area 50 as the projection image 60. The white image is an image projected onto the projection area 50 in a state in which the luminance of the projection apparatus 40 is set to a maximum value. Subsequently, the projection apparatus 40 acquires a captured image by capturing the projection image 60, that is, the white image with the camera 48. Subsequently, the projection apparatus 40 calculates an average value of the luminance of a region occupied by the white image in the captured image. The projection apparatus 40 acquires a maximum value of the luminance from the storage 42. Here, the maximum value of the luminance is an average value of luminance of the region occupied by a white image in the captured image obtained through the calibration operation executed when the projection apparatus 40 was shipped. Subsequently, the projection apparatus 40 calculates a deterioration rate of the light source based on the following Expression (1).

$$[ Deterioration rate of light source ] = 1 - ( [ av erage value of luminance ] / [ maximum value of luminance ] ) \qquad Expression ( 1 )$$

It can be said that the deterioration rate of the light source calculated by the method explained above is information indicating a degree of deterioration of the image quality of the projection image 60 projected by the projection apparatus 40, that is, projection image deterioration information. The projection image deterioration information is information calculated based on the captured image of the camera 48.

The calibration operation explained above is an example. A specific example of the calibration operation is not limited to the above. A value other than the deterioration rate of the luminance of the light source may be used as the deterioration rate of the light source.

After the deterioration rate of the light source is acquired as explained above, a billing amount can be calculated as in the first embodiment. For example, in the example of the customer C illustrated in FIG. 8, a discount of 10% is applied when the deterioration rate of the light source is 20% or more.

As explained above, in the modification 2, the deterioration information is deterioration information concerning the luminance. In particular, the deterioration information is information calculated based on data of an image captured by the camera 48 provided in the projection apparatus 40. With the configuration explained above, it is possible to appropriately determine a billing amount according to deterioration over time concerning the luminance of the projection apparatus 40.

Instead of the camera 48, another sensor may be used. For example, the projection apparatus 40 may include, in the apparatus, on an optical path from the light source 43 to a projection lens, a sensor that measures a light flux. The deterioration information concerning the luminance of the projection apparatus 40 can also be acquired by the sensor.

The modification 1 and the modification 2 may be combined. For example, deterioration information relating to a first discount condition may include information concerning an operating time of the projection apparatus, that is, operating time information and deterioration information relating to a second discount condition may include the projection image deterioration information explained above. In such a case, it can be said that the billing processing apparatus 30 outputs the billing amount based on the projection image deterioration information and the operating time information in step S15, that is, the billing amount output step.

With the combination explained above, since the billing processing apparatus 30 can evaluate the deterioration over time of the projection apparatus from various viewpoints, the billing processing apparatus 30 can appropriately determine the billing amount.

### Modification 3

A modification 3 is an embodiment in which the projection apparatus management system 1 is changed to output information concerning maintenance of the projection apparatus in the first embodiment, the modification 1, or the modification 2. Hereinafter, the modification 3 is explained. In the following explanation, explanation is sometimes omitted about portions common to the first embodiment, the modification 1, or the modification 2.

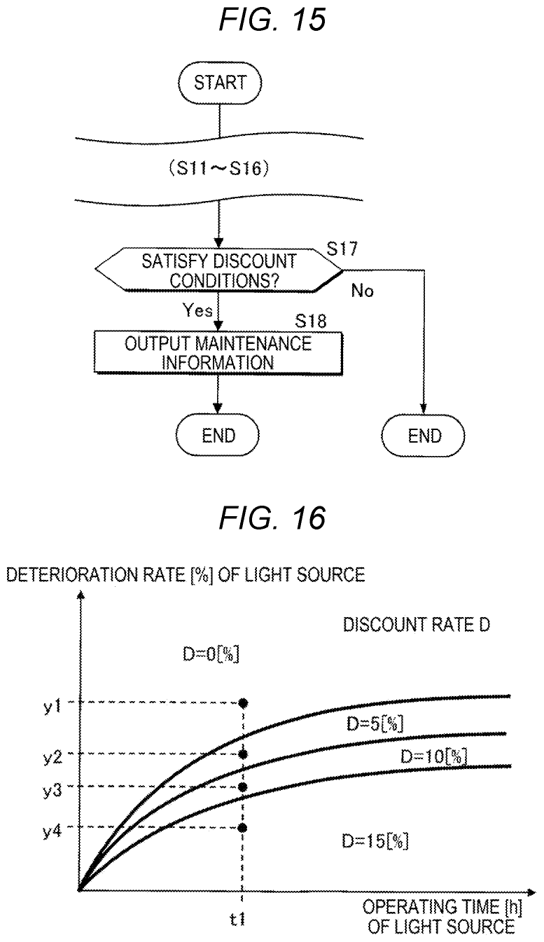

FIG. 15 is a flowchart illustrating an example of a flow of invoice output processing according to the modification 3. This processing is executed by, for example, the billing processing apparatus 30. Although steps S11 to S16 are not illustrated in FIG. 15, these steps can be the same as those in FIG. 11.

After step S16, in step S17, the billing processing apparatus 30 determines whether any one of the projection apparatuses satisfies the discount conditions. When none of the projection apparatuses satisfies the discount conditions, the processing in FIG. 15 ends.

When any one of the projection apparatuses satisfies the discount conditions, in step S18, the billing processing apparatus 30 outputs maintenance information for the projection apparatus. The maintenance information includes, for each of projection apparatuses satisfying the discount conditions, a projection apparatus ID and information indicating that maintenance work is necessary for the projection apparatus. The maintenance work includes, for example, replacement work for the projection apparatus. The maintenance work includes, for example, repair work for the projection apparatus. The information indicating that the maintenance work is necessary is represented as, for example, a message.

The output of the maintenance information in the billing processing apparatus 30 is executed, for example, by transmitting the maintenance information to the terminal 20. A format in the transmission is optional. For example, an HTML file may be used. For example, an e-mail may be used.

The terminal 20 acquires the maintenance information by receiving the maintenance information. The terminal 20 outputs the maintenance information. The output of the maintenance information in the terminal 20 is performed, for example, by displaying the maintenance information on a screen. Here, since whether the discount conditions are satisfied is determined based on the deterioration information, it can be said that the billing processing apparatus 30 outputs the maintenance information based on the deterioration information.

According to the modification 3, the owner can learn that there is a deteriorated projection apparatus. The owner can learn that maintenance work is necessary for the projection apparatus. For this reason, the owner can propose the maintenance work to a user of the relevant projection apparatus. Accordingly, the satisfaction of the user increases.

### Modification 4

A modification 4 is an embodiment in which the projection apparatus management system 1 is further changed to determine a discount rate by combining a plurality of pieces of deterioration information in the modification 2. In general, in a projection apparatus, a rate of deterioration over time sometimes changes depending on a way of use. For example, when a projection apparatus operated by setting a setting value concerning luminance to 100 and a projection apparatus operated by setting the setting value concerning luminance to 50 are compared, deterioration over time is gentler in the latter. In the modification 4, the discount rate is determined by combining a plurality of pieces of deterioration information considering such a tendency.

Hereinafter, the modification 4 is explained. In the following explanation, explanation is sometimes omitted about portions common to the modification 2.

FIG. 16 is a graph illustrating an example of fee information according to the modification 4. This graph can be used instead of, for example, the fee information illustrated in FIG. 8. The graph may be represented by a table or may be represented by a function. The horizontal axis represents an operating time of a light source and the vertical axis represents a deterioration rate of the light source. Curves indicate boundaries of discount rates.

For example, it is assumed that the operating time of a light source is t1 hours for a certain projection apparatus. When a deterioration rate of the light source of the projection apparatus is y1%, a discount rate of the projection apparatus is determined as 0%, that is, no discount is applied. When the deterioration rate of the light source of the projection apparatus is y2%, y3%, or y4%, the discount rate of the projection apparatus is determined as 5%, 10%, or 15%.

As explained above, in the modification 4, the deterioration information includes information concerning the operating time of the projection apparatus, that is, operating time information. The operating time information includes at least one of information concerning an operating time of a light source provided in the projection apparatus, information concerning an operating time of a light modulation device provided in the projection apparatus, and information concerning an operating time of a drive device that is provided in the projection apparatus and shifts pixels of the light modulation device. The deterioration information includes a deterioration rate of the light source, that is, projection image deterioration information. Further, it can be said that, in step S15, that is, in the billing amount output step, the billing processing apparatus 30 outputs the billing amount based on the projection image deterioration information and the operating time information.

With the determination method explained above, the discount rate is larger for a projection apparatus operating under milder operating conditions, that is, a projection apparatus having a smaller deterioration rate of a light source. As explained above, even when operating times of different projection apparatuses are the same, discount rates of the projection apparatuses can be changed according to usage statuses. Accordingly, since deterioration over time of the projection apparatuses can be appropriately evaluated, it is possible to appropriately determine a billing amount.

Those skilled in the art can optionally add, change, or delete elements in the first embodiment and the modifications. A unit of hardware configuring the projection apparatus management system 1 can be optionally changed. For example, the entire projection apparatus management system 1 including the registration processing apparatus 10, the terminal 20, and the billing processing apparatus 30 may be configured by a single computer, that is, a single information processing apparatus. For example, any one of the registration processing apparatus 10, the terminal 20, and the billing processing apparatus 30 may be configured by a plurality of computers. In that case, the plurality of computers may configure a single information processing apparatus.

In the first embodiment, the operation result report output processing illustrated in FIG. 9 and the invoice output processing illustrated in FIG. 11 are respectively started to be executed according to different kinds of operation. As a modification, these kinds of processing may be continuously executed. For example, after step S5, step S11 may be executed without waiting for operation by the owner. In that case, the information required in step S11 and subsequent steps, for example, the operation result report can be designed as appropriate to be acquired by the billing processing apparatus 30.

### Appendices

A summary of the present disclosure is appended below.

### Appendix 1

An Information Processing Apparatus That executes: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

With the information processing apparatus according to Appendix 1, the billing amount is output based on the deterioration information and the fee information of the projection apparatus. For this reason, the billing amount can be appropriately determined according to, for example, deterioration over time of the projection apparatus.

### Appendix 2

The information processing apparatus described in Appendix 1, wherein the deterioration information includes at least one of information concerning deterioration of a light source provided in the projection apparatus, information concerning deterioration of a light modulation device provided in the projection apparatus, and information concerning deterioration of a drive device provided in the projection apparatus and configured to shift a pixel of the light modulation device.

With the information processing apparatus according to Appendix 2, the deterioration information includes at least one of the information concerning the deterioration of the light source provided in the projection apparatus, the information concerning the deterioration of the light modulation device provided in the projection apparatus, and the information concerning the deterioration of the drive device provided in the projection apparatus and configured to shift the pixel of the light modulation device. For this reason, it is possible to appropriately evaluate the deterioration over time of the projection apparatus and appropriately determine the billing amount.

### Appendix 3

The information processing apparatus described in Appendix 1 or 2, further executing outputting maintenance information based on the deterioration information.

With the information processing apparatus according to Appendix 3, by outputting the maintenance information based on the deterioration information, an owner can learn that maintenance work is necessary for the projection apparatus. For this reason, the owner can propose the maintenance work to a user of the relevant projection apparatus. Accordingly, the satisfaction of the user increases.

### Appendix 4

The information processing apparatus described in any one of Appendices 1 to 3, wherein the deterioration information includes projection image deterioration information indicating a degree of deterioration in image quality of a projection image projected by the projection apparatus, the projection apparatus includes an imaging device that captures the projection image to thereby acquire a captured image, and the projection image deterioration information is information calculated based on the captured image.

With the information processing apparatus according to Appendix 4, since the deterioration information includes the projection image deterioration information calculated based on the captured image, it is possible to appropriately evaluate the deterioration over time of the projection apparatus. For this reason, it is possible to appropriately determine the billing amount according to deterioration over time concerning luminance of the projection apparatus.

### Appendix 5

The information processing apparatus described in Appendix 4, wherein the deterioration information includes operating time information concerning an operating time of the projection apparatus, the operating time information includes at least one of information concerning an operating time of a light source provided in the projection apparatus, information concerning an operating time of a light modulation device provided in the projection apparatus, and information concerning an operating time of a drive device provided in the projection apparatus and configured to shift a pixel of the light modulation device, and the information processing apparatus outputs the billing amount based on the projection image deterioration information and the operating time information.

With the information processing apparatus according to Appendix 5, by outputting the billing amount based on the projection image deterioration information and the operating time information, the information processing apparatus can appropriately determine the billing amount according to the deterioration over time of the projection apparatus in which the operating time information is considered.

### Appendix 6

A billing amount output method including: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

With the billing amount output method according to Appendix 6, the billing amount is output based on the deterioration information and the fee information of the projection apparatus. For this reason, the billing amount can be appropriately determined according to, for example, deterioration over time of the projection apparatus.

### Appendix 7

A non-transitory computer-readable storage medium storing a program for causing a computer to execute: acquiring at least one of identification information indicating a projection apparatus and identification information indicating a user of the projection apparatus; acquiring deterioration information concerning deterioration of image quality of the projection apparatus in a first period; acquiring fee information concerning a usage fee of the projection apparatus; and outputting a billing amount relating to the projection apparatus in the first period based on the deterioration information and the fee information.

With the non-transitory computer-readable storage medium storing the program according to Appendix 7, the billing amount is output based on the deterioration information and the fee information of the projection apparatus. For this reason, the billing amount can be appropriately determined according to, for example, deterioration over time of the projection apparatus.

What is claimed is:

1. An information processing apparatus that executes:
acquiring at least one of identification information indicating a projection apparatus and identification information indicating a user of the projection apparatus;
acquiring deterioration information concerning deterioration of image quality of the projection apparatus in a first period;
acquiring fee information concerning a usage fee of the projection apparatus; and
outputting a billing amount relating to the projection apparatus in the first period based on the deterioration information and the fee information.

2. The information processing apparatus according to claim 1, wherein the deterioration information includes at least one of
information concerning deterioration of a light source provided in the projection apparatus,
information concerning deterioration of a light modulation device provided in the projection apparatus, and
information concerning deterioration of a drive device provided in the projection apparatus and configured to shift a pixel of the light modulation device.

3. The information processing apparatus according to claim 1, further executing outputting maintenance information based on the deterioration information.

4. The information processing apparatus according to claim 1, wherein
the deterioration information includes projection image deterioration information indicating a degree of deterioration in image quality of a projection image projected by the projection apparatus,
the projection apparatus includes an imaging device that captures the projection image to thereby acquire a captured image, and
the projection image deterioration information is information calculated based on the captured image.

5. The information processing apparatus according to claim 4, wherein
the deterioration information includes operating time information concerning an operating time of the projection apparatus,
the operating time information includes at least one of
information concerning an operating time of a light source provided in the projection apparatus,
information concerning an operating time of a light modulation device provided in the projection apparatus, and
information concerning an operating time of a drive device provided in the projection apparatus and configured to shift a pixel of the light modulation device, and
the information processing apparatus outputs the billing amount based on the projection image deterioration information and the operating time information.

6. A billing amount output method comprising:
acquiring at least one of identification information indicating a projection apparatus and identification information indicating a user of the projection apparatus;
acquiring deterioration information concerning deterioration of image quality of the projection apparatus in a first period;
acquiring fee information concerning a usage fee of the projection apparatus; and
outputting a billing amount relating to the projection apparatus in the first period based on the deterioration information and the fee information.

7. A non-transitory computer-readable storage medium storing a program for causing a computer to execute:
acquiring at least one of identification information indicating a projection apparatus and identification information indicating a user of the projection apparatus;
acquiring deterioration information concerning deterioration of image quality of the projection apparatus in a first period;
acquiring fee information concerning a usage fee of the projection apparatus; and
outputting a billing amount relating to the projection apparatus in the first period based on the deterioration information and the fee information.
